(19) United States
(12) Patent Application Publication
(10) Pub. No.: US 2006/0118640 A1
(43) Pub. Date: Jun. 8, 2006

(54) Integrated circuit chip with flash memory and identification function

(75) Inventors: Gordon Yu, Taipei City (TW); Hung-Tse Ho, Taipei City (TW); Yi-Hua Ho, Kaohsiung City (TW); Ching-Lung Wu, Baihe Township (TW)

Correspondence Address: BACON & THOMAS, PLLC, 625 SLATERS LANE, FOURTH FLOOR, ALEXANDRIA, VA, 22314, US

(73) Assignee: C-One Technology Corporation, Hsin-Chu City (TW)

(21) Appl. No.: 11/109,621

(22) Filed: Apr. 20, 2005

(30) Foreign Application Priority Data
Dec. 3, 2004 (TW) 093137405

(51) Int. Cl. G06K 19/06

(52) U.S. Cl. 235/492

(57) ABSTRACT

The present invention provides an integrated circuit chip with flash memory and identification function, which comprises a base, a body, at least one flash memory die, and a codeless die. The flash memory die and the codeless die are disposed on the base and packaged in the same body, such that the integrated circuit chip is equipped with the flash memory and personal identification function. Further, the integrated circuit chip can connect to a die controling chip for providing the function of data access and data security. That is, when the identification code stored in the codeless die matches the identification data included in the received wireless signal, the die controling chip allows the flash memory die to process data access.

### BACKGROUND OF THE INVENTION

1. Field of the Invention

The present invention relates to a flash memory integrated circuit (IC) chip, and more particularly, to an integrated circuit chip with flash memory and identification function.

2. Description of Related Art

For the flash memory can maintain stored data without power supply, the written data can still be stored in the memory after turning off the power. Further, with the characteristics of small volume and large capacity, the flash memory is widely applied in various portable 3C (communication, computer, and consumer electronics) products, including personal digital assistants (PDA), wireless mobile communication devices such as mobile phones and personal handy-phone systems (PHS), and digital memory cards (like compact flash (CF) cards, multimedia cards (MMC), and smart media (SM) cards) or movable drives compatible with digital cameras, wherein such kinds of digital memory cards or movable drives are generally carried along with users. However, in the daily life, the user may also have to carry along various identification devices, such as the building access card or identification card. As a result, the user has to carry along not only the aforementioned memory cards or USB drives, but also the identification devices. It becomes quite inconvenient for the user to carry so many things along.

Therefore, it is desirable to provide an improved integrated circuit chip with flash memory and identification function to mitigate and/or obviate the aforementioned problems.

### SUMMARY OF THE INVENTION

The integrated circuit chip with flash memory and identification function of the present invention comprises a base, a body, at least one flash memory die, and a codeless die. The flash memory die and the codeless die are located on the base and packaged in the same body, wherein the codeless die is stored with an identification code, and returns a response signal when receiving a wireless signal. Consequently, various different identification devices can be integrated with the flash memory die such that the integrated circuit chip with flash memory and identification function is equipped with various functions.

The integrated circuit chip with flash memory and identification function further connects to a die controling chip for retrieving the identification code stored in the codeless die, comparing the identification code with identification data included in the wireless signal received by the codeless die, and allowing the flash memory die to process data access if the identification code matches the identification data thereby providing the data security service. The abovementioned die controling chip and the integrated circuit chip with flash memory and identification function can be disposed on the same circuit board, or integrated on an integrated circuit board. Furthermore, the codeless die is stored with several identification codes each respectively corresponding to the flash memory dies in the body, such that each flash memory die has its own identification code to process the data security service.

The codeless die is preferably a radio frequency identification (RFID) die, a die with bar code function, or other equivalent dies equipped with wireless communication and identification function.

The aforementioned codeless die is superimposed on the flash memory die. Further, multiple flash memory dies can also be superimposed on each other and packaged in the same body.

Other objects, advantages, and novel features of the invention will become more apparent from the following detailed description when taken in conjunction with the accompanying drawings.

### BRIEF DESCRIPTION OF THE DRAWINGS

FIG. 1 illustrates a schematic drawing of a package structure of a preferred embodiment according to the present invention; and

FIG. 2 illustrates a schematic drawing of a circuit structure of the preferred embodiment according to the present invention.

### DETAILED DESCRIPTION OF THE PREFERRED EMBODIMENT

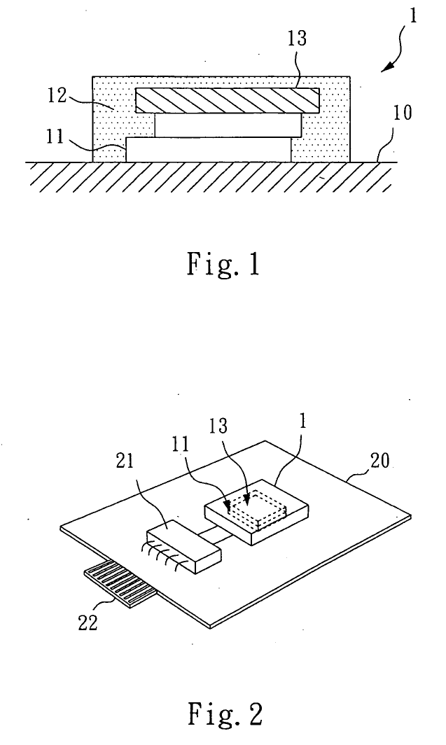

Please refer to FIG. 1. FIG. 1 illustrates a schematic drawing of a package structure of a preferred embodiment according to the present invention. As show in FIG. 1, the integrated circuit chip 1 with flash memory and identification function comprises: a base 10, a flash memory die 11 located on the base 10, and a codeless die 13, wherein the flash memory die 11 and the codeless die are packaged in the same body 12. In this embodiment, the codeless die 13 is a radio frequency identification (RFID) die superimposed on the flash memory die 11 in order to save the occupied area. The codeless die 13 itself is stored with an identification code, therefore the codeless die 13 can return a response signal when receiving a wireless signal, wherein the response signal comprises its identification code such that the response signal is equipped with identification function.

With reference to FIG. 2, it illustrates a schematic drawing of a circuit structure of the preferred embodiment according to the present invention. In FIG. 2, the integrated circuit chip 1 and a die controling chip 21 are disposed on a circuit board 20 such as a memory card. When the host (not shown in FIG. 2) processes data access to the flash memory die 11 of the integrated circuit chip 1 through the interface 22 of the memory card, the personal data should be inputted in advance under the control of the die controling chip 21. Then the die controling chip 21 compares the inputted personal data with the identification code stored in the codeless die 13 of the integrated circuit chip 1, and allows the host to process data access if the inputted personal data matches the identification code so as to achieve the data security service.

According to the description mentioned above, the flash memory die 11 and the codeless die 13 of the present invention are packaged in one integrated circuit chip 1. Therefore, the memory card or movable drive manufactured with such kind of integrated circuit chip 1 can be regarded as an identification card so as to simplify the devices that the user has to carry along. Meanwhile, the data stored in the memory card or movable drive can be securely protected without being arbitrarily accessed thereby achieving the purpose of data security.

Although the present invention has been explained in relation to its preferred embodiment, it is to be understood that many other possible modifications and variations can be made without departing from the spirit and scope of the invention as hereinafter claimed.

What is claimed is:

1. An integrated circuit chip with flash memory and identification function, comprising:
a base;
a body located on the base;
at least one flash memory die coupled to the base and packaged in the body; and
a codeless die packaged in the body, wherein the codeless die is stored with an identification code, and returns a response signal when receiving a wireless signal.

2. The integrated circuit chip with flash memory and identification function as claimed in claim 1 further connecting to a die controling chip, wherein the die controling chip retrieves the identification code stored in the codeless die, compares with inputted data, and allows the at least one flash memory die to process data access if the identification code matches the inputted data.

3. The integrated circuit chip with flash memory and identification function as claimed in claim 1, wherein the codeless die is superimposed on the at least one flash memory die.

4. The integrated circuit chip with flash memory and identification function as claimed in claim 1, wherein the codeless die is a radio frequency identification (RFID) die.

5. The integrated circuit chip with flash memory and identification function as claimed in claim 2, wherein the die controling chip and the integrated circuit chip with flash memory and identification function are disposed on the same circuit board.
